(19) United States
(12) Patent Application Publication
(10) Pub. No.: US 2025/0119920 A1
(43) Pub. Date: Apr. 10, 2025

(54) METHOD, DEVICE, AND SYSTEM FOR RESOURCE MANAGEMENT IN WIRELESS NETWORKS

(71) Applicant: ZTE CORPORATION, Shenzhen (CN)

(72) Inventors: Xiubin SHA, Shenzhen (CN); Bo DAI, Shenzhen (CN); He HUANG, Shenzhen (CN); Yuan GAO, Shenzhen (CN); Ting LU, Shenzhen (CN); Li NIU, Shenzhen (CN); Jie TAN, Shenzhen (CN)

(21) Appl. No.: 18/841,948

(22) PCT Filed: Apr. 22, 2022
(86) PCT No.: PCT/CN2022/088619

§ 371 Date: Aug. 27, 2024

(51) Int. Cl. H04W 72/23; H04W 72/0446

(52) U.S. Cl. CPC H04W 72/23; H04W 72/0446

(57) ABSTRACT

A method includes: receiving a first message from a network element in the wireless network, the first message comprising validity information for a downlink transmission resource associated with a downlink transmission; and in response to the validity information indicating the downlink transmission resource being invalid, skipping monitoring the downlink transmission resource.

### TECHNICAL FIELD

This disclosure is directed generally to wireless communications, and particularly to a method, device, and system for resource management and power saving in a wireless network.

### BACKGROUND

Energy efficiency is a key performance index in the wireless communication network. Controlling power consumption and reducing energy cost is critical for developing and deploying a wireless communication network. Energy saving technology plays an essential role in achieving this goal. From a User Equipment (UE) perspective, UE battery life has great impact on user experience. From a network perspective, energy consumption is a key factor to consider for improving investment efficiency for operators. It is beneficial to have the capability to dynamically control the power consumption of various network elements, and/or network resources, yet still meet performance requirement.

### SUMMARY

This disclosure is directed to a method, device, and system for resource management and power saving in a wireless network.

In some embodiments, a method performed by a device in a wireless network is disclosed. The method may include: receiving a first message from a network element in the wireless network, the first message comprising validity information for a downlink transmission resource associated with a downlink transmission; and in response to the validity information indicating the downlink transmission resource being invalid, skipping monitoring the downlink transmission resource.

In some embodiments, a method performed by a first Network Element (NE) in a wireless network is disclosed. The method may include: transmitting, to a second NE, a first handover request message requesting to hand over a User Equipment (UE) from the first NE to a first cell in the second NE, the first handover request message comprising at least one of: an identifier of the first cell; a handover cause; a load information of the first cell; or a power saving mode associated with a power saving in the first NE.

In some embodiments, there is a network element or a UE comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows an exemplary Downlink (DL) slot shutdown scheme.

FIG. 5 shows an exemplary message flow for notifying slot/symbol shutdown information.

FIG. 6 shows an exemplary bitmap covers slots under various subcarrier spacing.

FIG. 7 shows an exemplary DL symbol shutdown scheme.

FIGS. 8-10 show exemplary handover scenarios.

### DETAILED DESCRIPTION

### Wireless Communication Network

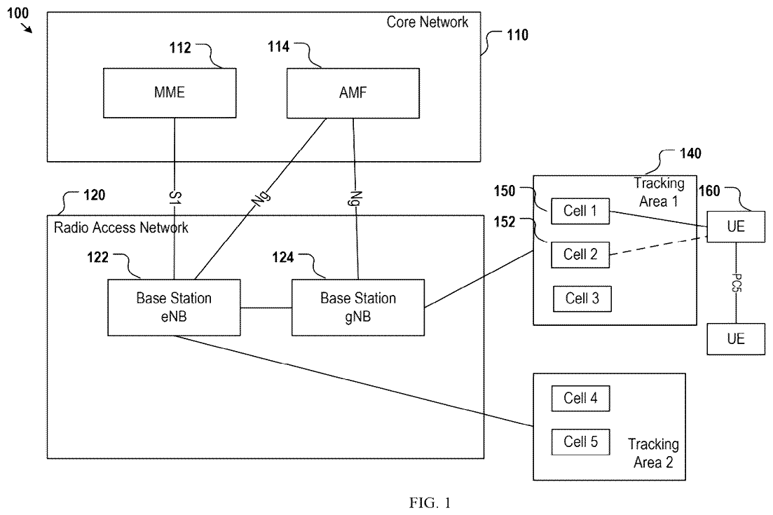

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

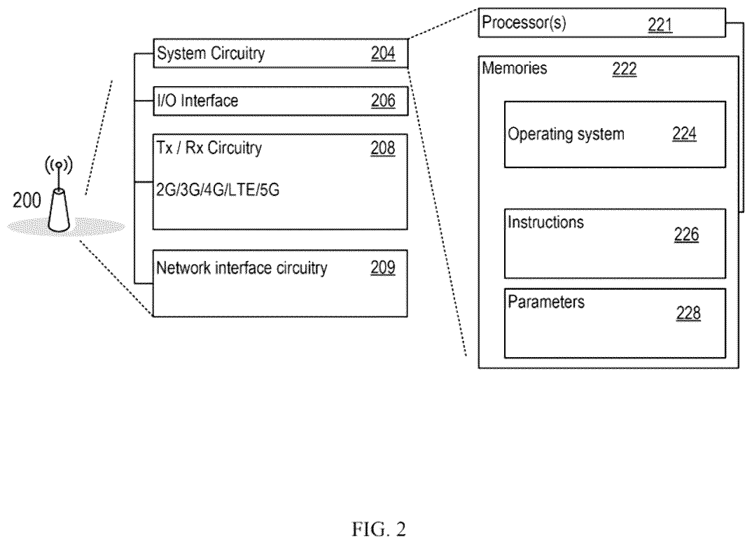

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

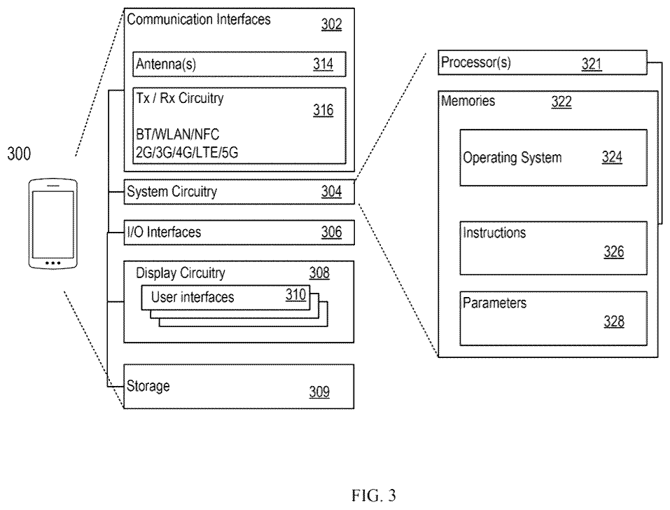

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Power Saving in Wireless Network

Energy consumption has become a key part of the operators' operating expenses (OPEX). In wireless networks, significant energy consumption comes from the radio access network and in particular from the hardware circuitries such as Active Antenna Unit (AAU), Radio Unit (RU), Remote Radio Unit (RRU), Power Amplifier (PA), and the like.

In the wireless network, to adapt different service requirements and trade-offs, multiple network operation modes may be implemented. One mechanism for saving network energy consumption is flexible downlink transmission management, utilizing fast reacting hardware which may be activated and deactivated in the time scale of hundreds of microseconds to hundreds of milliseconds. For example, the downlink transmission may be conducted in slot level, and symbol level. A base station, based on certain load and traffic management policy, may determine to shutdown certain slots and/or symbols. When a slot or symbol is shutdown, it is considered to be invalid or reserved, and a UE will not monitor the shutdown resources. Via this shutdown mechanism, related hardware, such as Radio Frequency (RF) circuitries, Transmitting (TX)/Receiving (RX) antenna, etc., may be deactivated to save power consumption.

Further, in the wireless network, multiple RAN nodes (e.g., gNBs, eNBs, or ng-eNBs, or a combination thereof) may interact with each other to exchange power saving related information with regard to various resources and statuses. The resources may include: cell, carrier, beam, network slice, Bandwidth Part (BWP), bandwidth represented by a frequency range, slot, or symbol. The statuses may include a power saving mode/state. The power saving information may further include load information. With power saving information from other network elements, a network element such as a RAN node, may make a more informed choice, for example, when attempting to shut down a certain resource such as a slot or a symbol. In some implementations, Artificial Intelligence (AI) model may be developed and deployed, using power saving information as input, to determine a pattern to shut down the resources such as slot and symbol.

From the perspective of slot/symbol shutdown, it is important for the RAN node to notify the UE the timing to skip and resume signal monitoring.

In this disclosure, various embodiments are disclosed for implementing base station and UE coordination on downlink slot/symbol shutdown.

### Embodiment 1: Downlink Slot Shutdown

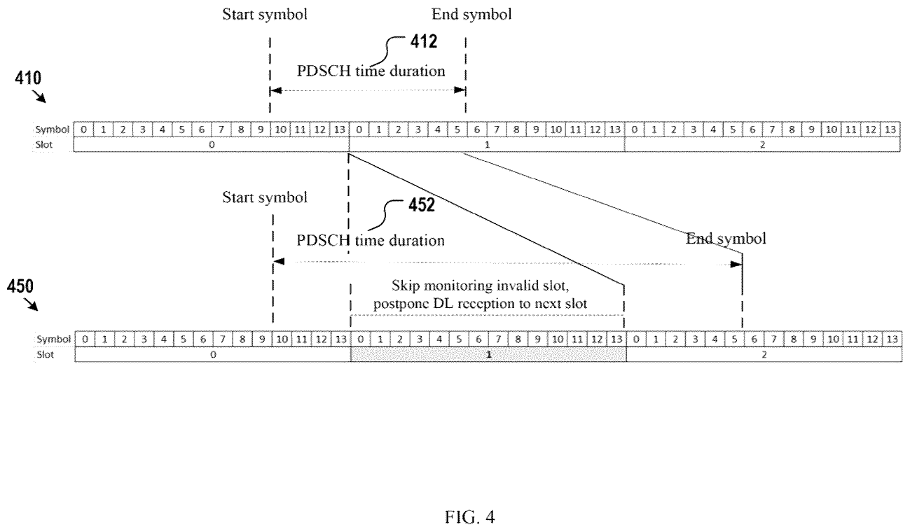

FIG. 4 illustrates an example DL slot shutdown scheme. The upper row 410 shows the UE monitoring behavior when no DL slot is shutdown, and the lower row 450 shows the UE monitoring behavior when the DL slot 1 is shutdown. In this disclosure, when a DL slot is shutdown, the DL slot is invalid, for example, for signal/data transmission. The shutdown slot may also be referred to as a reserved slot which is not intended for a UE to monitor.

A DL transmission may include a Physical Downlink Control Channel (PDCCH) transmission, and a Physical Downlink Shared Channel (PDSCH) transmission. Using PDSCH as an example, in exemplary implementations, when the PDSCH transmission time duration collides with an invalid (shutdown) slot, it may be postponed to the next slot that is valid. Referring to FIG. 4, the PDSCH transmission time duration 412 lasts 10 symbols (i.e., from symbol 10 in slot 0 to symbol 5 in slot 1 in upper row 410). During this PDSCH transmission session, the base station (e.g., gNB, eNB, or ng-eNB) may decide to shutdown slot 1. The lower row 450 shows that slot 1 (shaded) is shutdown thus invalid. The PDSCH transmission is postponed from slot 1 to slot 2, and ends in symbol 5 of slot 2. As shown in FIG. 4, with slot 1 shutdown, initially assigned symbol 0 to symbol 5 in slot 1 are shifted to the next slot, which is slot 2. In this case, UE will skip monitoring slot 1, and resume monitoring symbols 0-5 in slot 2, which map to originally assigned symbols 0-5 in slot 1. With slot 1 being shutdown, the new PDSCH time duration is shown as 452 in lower row 450.

In one implementation, when a slot is shutdown for a DL transmission, the DL transmission may be postponed to a next n-th slot, where n is a positive integer and may be predetermined or be signaled to the UE. In the example shown in FIG. 4, n=1.

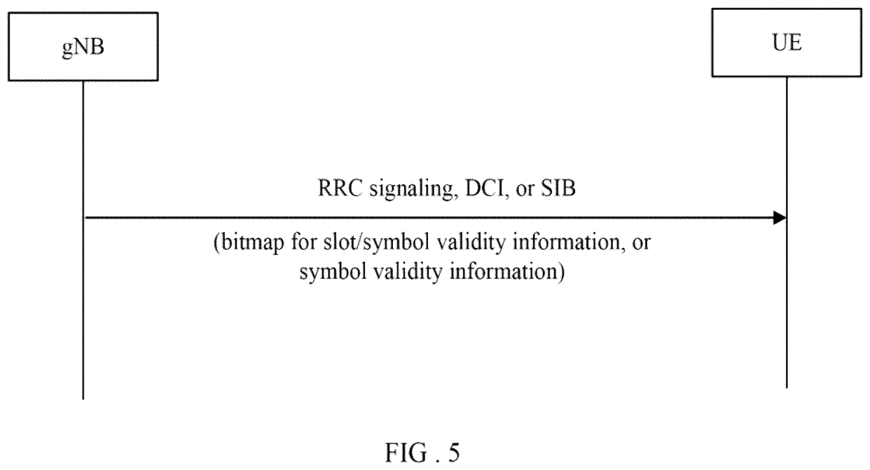

Referring to FIG. 5, the DL slot shutdown information may be signaled by the base station to the UE, via at least one of a Radio Resource Control (RRC) message, a Medium Access Control Control Element (MAC CE), a Downlink Control Information (DCI) message, or a system information message (e.g., using System Information Block (SIB)). The RRC, SIB, MAC CE, or DCI message may carry a bitmap (e.g., invalidSlotBitmap, or reservedSlotBitmap) indicating which slot(s) is to be shutdown. For example, each bit in the bitmap may correspond to a slot. When the bit is set to “1”, the corresponding slot is invalid (shutdown, or reserved) and will not be used or monitored by the UE.

In a wireless network, there may exist different sub-carrier spacings (SCS). The SCS may have an impact on the number of slots in each frame. Table 1 below shows exemplary SCS and the corresponding number of slots in each frame, for normal cyclic prefix.

TABLE 1
Number of OFDM symbols per slot, slots per frame, and slots per
subframe for normal cyclic prefix

| subcarrierSpacing | | | |
|---|---|---|---|
| (μ) | N_{symb}^{slot} | Nₛₗₒₜ^{frame,μ} | Nₛₗₒₜ^{subframe,μ} |
| 0 (15 kHz) | 14 | 10 | 1 |
| 1 (30 kHz) | 14 | 20 | 2 |
| 2 (60 kHz) | 14 | 40 | 4 |
| 3 (120 kHz) | 14 | 80 | 8 |
| 4 (240 kHz) | 14 | 160 | 16 |

Table 2 below shows exemplary SCS and the corresponding number of slots in each frame, for extended cyclic prefix.

TABLE 2
Number of OFDM symbols per slot, slots per frame, and slots per
subframe for extended cyclic prefix

| μ | N_{symb}^{slot} | Nₛₗₒₜ^{frame,μ} | Nₛₗₒₜ^{subframe,μ} |
|---|---|---|---|
| 2 | 12 | 40 | 4 |

As can be seen, under different SCS, each frame may have different number of slots. For example, for a 15 kHz SCS, there are 10 slots per frame; for a 240 kHz SCS, there are 160 slots per frame. In this disclosure, multiple options for indicating invalid slots are described below.

### Option 1

In this option, a bitmap with a fixed length of 160 bits is selected for indicating invalid slot information. For example:
invalidSlotBitmap (or reservedSlotBitmap) BIT STRING (SIZE (160))

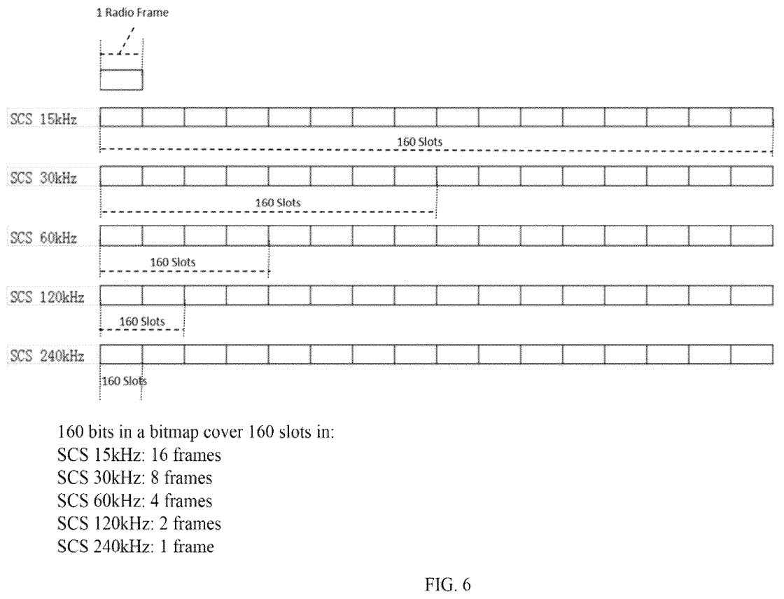

As 160 is the maximum slots that a frame may have under maximal SCS configurations, depending on the SCS, the 160 bits in the bitmap may cover slots spreading multiple frames, as shown in FIG. 6:
For SCS 240 kHz, in time domain, each bit in the bit map corresponds to (one to one map) each slot of one radio frame.
For SCS 120 kHz, in time domain, each bit in the bit map corresponds to (one to one map) each slot of two radio frames.
For SCS 60 kHz, in time domain, each bit in the bit map corresponds to (one to one map) each slot of four radio frames.
For SCS 30 kHz, in time domain, each bit in the bit map corresponds to (one to one map) each slot of eight radio frames.
For SCS 15 kHz, in time domain, each bit in the bit map corresponds to (one to one map) each slot of sixteen radio frames.

### Option 2

Use a bitmap with variable length, depending on the SCS. For example:

| | |
|---|---|
| invalidSlotBitmap (or reservedSlotBitmap) | CHOICE{ |
| SCS 240kHzBIT STRING (SIZE (160)), | |
| SCS 120kHzBIT STRING (SIZE (80)), | |
| SCS 60kHzBIT STRING (SIZE (40)), | |
| SCS 30kHzBIT STRING (SIZE (20)), | |
| SCS 15kHzBIT STRING (SIZE (10)) | |
| } | |

In this option, each bit in the bitmap one to one maps to one slot in one radio frame. For example, when SCS is 15 kHz, the bitmap only needs 10 bits, to map to each of the 10 slots in one frame under this SCS setting. For another example, when SCS is 120 kHz, the bitmap needs 80 bits, as there are 80 slots per frame under this SCS setting.

### Option 3

Unlike the previous two options, which use just one bitmap, in this option, there is a bitmap applies to up to two slots, each bit corresponds to a symbol in the up to two slots. For example, when the bit is set to 1, the corresponding symbol in the up to two slots is shutdown (invalid). This option also provides a periodicity, so the symbol shutdown pattern specified in the bitmap is repeated following the periodicity.

An example information element for this option is listed below:

| | | |
|---|---|---|
| InvalidSymbolPattern ::= | SEQUENCE { | |
| symbols | CHOICE { | |
| oneSlot | BIT STRING (SIZE (14)), | |
| twoSlots | BIT STRING (SIZE (28)) | |
| }, | | |
| periodicityAndPattern | CHOICE { | |
| n2 | BIT STRING (SIZE (2)), | |
| n4 | BIT STRING (SIZE (4)), | |
| n5 | BIT STRING (SIZE (5)), | |
| n8 | BIT STRING (SIZE (8)), | |
| n10 | BIT STRING (SIZE (10)), | |
| n20 | BIT STRING (SIZE (20)), | |
| n40 | BIT STRING (SIZE (40)) | |
| } | | OPTIONAL, -- Need |
| M | | |
| ... | | |
| } | | |

In the above definition:
symbols: A symbol level bitmap in time domain for one or two slots, with each bit in the bitmap corresponds to one symbol.
periodicityAndPattern: A time domain repetition pattern at which the pattern is repeated. This slot pattern repeats itself continuously.

### Embodiment 2: Downlink Symbol Shutdown

In this disclosure, not only the transmission resource may be shutdown in a slot level, as described in embodiment 1, the transmission resource may also be shutdown in a symbol level.

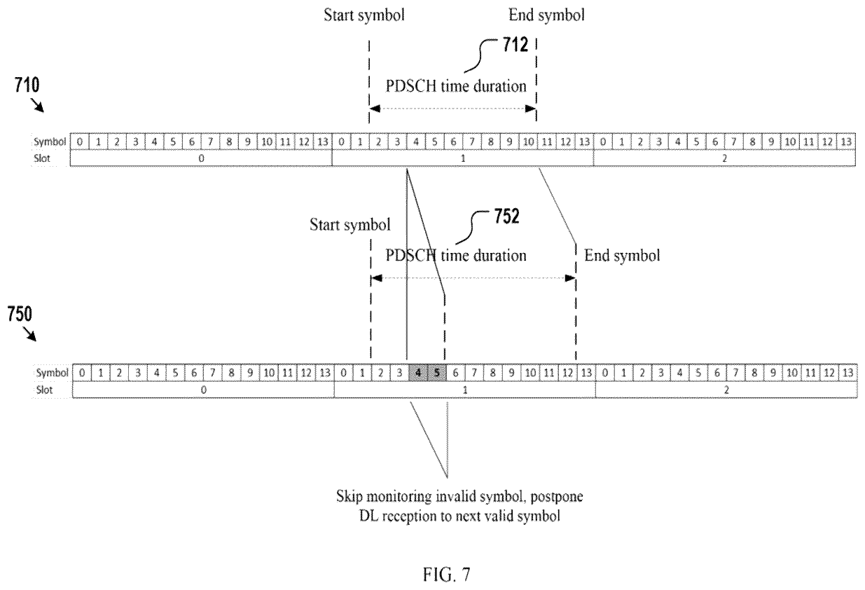

FIG. 7 illustrates an example DL symbol shutdown scheme. The upper row 710 shows the UE monitoring behavior when no DL symbol is shutdown, and the lower row 750 shows the UE monitoring behavior when the DL symbols 4 and symbol 5 in slot 1 are shutdown. In this disclosure, when a DL symbol is shutdown, the DL symbol is invalid, for example, for signal/data transmission. The shutdown symbol may also be referred to as a reserved symbol which is not intended for a UE to monitor.

A DL transmission may include a PDCCH transmission, and a PDSCH transmission. Using PDSCH as an example, in exemplary implementations, when the PDSCH transmission time duration collides with an invalid (shutdown) symbol, it may be postponed to the next symbol that is valid. Referring to FIG. 7, the PDSCH transmission time duration 712 lasts 9 symbols (i.e., from symbols 2-10 in slot 1 in the upper row 710). During this PDSCH transmission session, the base station (e.g., gNB, eNB, or ng-eNB) may decide to shutdown symbols 4-5 in slot 1. The lower row 750 shows that symbols 4-5 (shaded) in slot 1 are shutdown thus invalid. The PDSCH transmission is postponed to the next valid symbol (i.e., symbol 6 in slot 1). As shown in FIG. 7, lower row 750, the DL transmission ends at symbol 12 in slot 1. As there are two symbols being shutdown for the DL transmission, the whole DL transmission is shifted by 2 symbols, and has a new PDSCH time duration 752.

The DL symbol shutdown information may be signaled by the base station to the UE, via at least one of an RRC message, a MAC CE, a SIB, or a DCI message, in a similar manner as shown in FIG. 5. The RRC, MAC CE, SIB, or DCI message may carry a bitmap (e.g., invalidSymbolBitmap, or reservedSymbolBitmap) indicating which symbol(s) is to be shutdown. For example, each bit in the bitmap may correspond to a symbol. When the bit is set to “1”, the corresponding symbol is invalid (shutdown, or reserved) and will not be used or monitored by the UE.

In this disclosure, multiple options for indicating invalid symbols are described below.

### Option 1

Considering that there are same number of symbols per slot for different SCS configurations (under normal cyclic prefix), the invalidSlotBitmap or reservedSlotBitmap, as described above, may be defined as fixed length bitmap:
invalidSymbolBitmap (or reservedSymbolBitmap) BIT STRING (SIZE (14))

Each bit the bitmap corresponds to one symbol in one slot. For SCS 60 kHz with extended cyclic prefix, two bits (e.g., the last 2 bits) are reserved.

### Option 2

In this option, there is a bitmap applies to up to two slots, each bit corresponds to a symbol in the up to two slots. For example, when the bit is set to 1, the corresponding symbol in the up to two slots is shutdown (invalid). This option also provides a periodicity, so the symbol shutdown pattern specified in the bitmap is repeated following the periodicity.

An example information element for this option is listed below:

| | | |
|---|---|---|
| InvalidSymbolPattern ::= | SEQUENCE { | |
| symbols | CHOICE { | |
| oneSlot | BIT STRING (SIZE (14)), | |
| twoSlots | BIT STRING (SIZE (28)) | |
| }, | | |
| periodicityAndPattern | CHOICE { | |
| n2 | BIT STRING (SIZE (2)), | |
| n4 | BIT STRING (SIZE (4)), | |
| n5 | BIT STRING (SIZE (5)), | |
| n8 | BIT STRING (SIZE (8)), | |
| n10 | BIT STRING (SIZE (10)), | |
| n20 | BIT STRING (SIZE (20)), | |
| n40 | BIT STRING (SIZE (40)) | |
| } | | OPTIONAL, -- Need |
| M | | |
| ... | | |
| } | | |

In the above definition:
symbols: A symbol level bitmap in time domain for one or two slots, with each bit in the bitmap corresponds to one symbol.
periodicityAndPattern: A time domain repetition pattern at which the pattern is repeated. This slot pattern repeats itself continuously.

Refer to FIG. 7 for an example on the periodicity. In the lower row 750, symbols 4-5 are shutdown in slot 1, which may be represented by two bits in InvalidSymbolPattern: symbols. The shutdown of these two symbols may be periodic, that is, for example, these same two symbols (i.e., symbols with same symbol number) may be shutdown every 1 frame, every 2 frames, every 4 frames, etc. The periodicity is defined by InvalidSymbolPattern: periodicity AndPattern.

### Embodiment 3

The power saving schemes as described in embodiment 1 and embodiment 2 may have an impact on the UE handover (HO) scenarios. Specifically, when one base station determines to shutdown some slots and/or symbols, or other resources, it may need to transfer (aggregate) some UE traffic/load to another base station, by performing a handover of the UE.

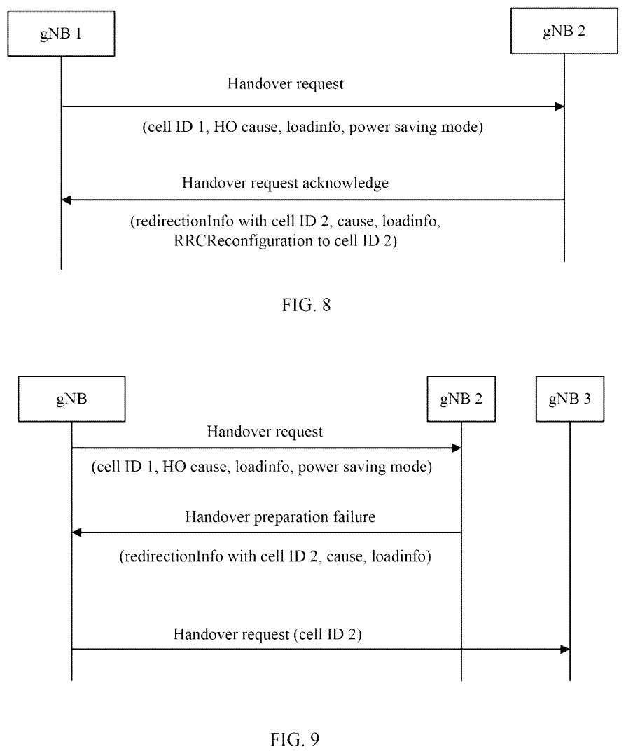

In this embodiment, one base station initiates a handover request, to request handover a UE to a target cell in second base station. The second base station, based on its policy, and with reference to load information, may accept the handover request, but use a different cell to host the UE. Details are described below with reference to FIG. 8.

### Step 1

Base station 1 sends a handover request message to base station 2. The handover request message may include at least one of: a target cell in base station 2, a handover cause, a load information of the source cell or cells managed by base station 1, or a power saving mode associated with base station 1.

The handover cause may include at least one of:
a load aggregation from base station 1 to base station 2;
a load transfer from base station 1 to base station 2;
a load balance between base station 1 and base station 2;
an overload condition in base station 1;
network power saving in base station 1; or
cell shutdown in base station 1.

The load information may include at least one of:
a Physical Resource Block (PRB) usage in the source cell or cells managed by base station 1;
a PRB usage per beam in the source cell or cells managed by base station 1;
a Control Channel Element (CCE) usage in the source cell or cells managed by base station 1;
a CCE usage per beam in the source cell or cells managed by base station 1;
a number of active UEs in the source cell or cells managed by base station 1; or
a number of active UEs per beam in the source cell or cells managed by base station 1.

The power saving mode may include at least one of:
a cell shutdown mode in which at least one cell is shutdown;
a carrier shutdown mode in which at least one carrier is shutdown;
a beam shutdown mode in which at least one beam is shutdown;
a slot shutdown mode in which at least one slot is shutdown;
a symbol shutdown mode in which at least one symbol is shutdown;
a deep sleep mode;
a light sleep mode; or
normal mode.

When a base station (or other network element, UE, etc.) is in the deep sleep mode, at least one of: radio circuitries, radio resources, or network components is shutdown.

When a base station (or other network element, UE, etc.) is in the light sleep mode, the base station transmits or receives radio signal following a larger Discontinuous Reception (DRX) cycle or time interval than in the normal mode. For example, multiple DRX cycles may be configured and one of the DRX cycles may be used in a normal mode. In the light sleep mode, a longer DRX cycles may be selected from the configured DRX cycles.

### Step 2

Base station 2 may decide not to grant access to the UE in the target cell as specified in the handover request. However, there is a new target cell in base station 2 which may provide same coverage as the target cell, or the new target cell may satisfy the Quality of Service (QOS) requirement of the UE. In this case, the base station 2 may determine to accept the UE in the new target cell. The base station 2 may send a handover request acknowledge message to base station 1. The handover request acknowledge message may include information to facilitate re-directing the UE to the new target cell. The information may include at least one of:
a cause;
a load information of the target cell and/or the new target cell (target cell and new target cell may be identified by cell identifier, such as Cell Global Identity (CGI));
a redirection information associated with the new target cell; or
an RRC reconfiguration information associated with the new target cell.

The cause may include at least one of: redirection triggered by load balance, redirection triggered by overload, redirection triggered by network power saving, or redirection triggered by cell to be shutdown. For example, the originally selected target cell by base station is shutdown or is going to be shutdown. The cause of “redirection triggered by overload” may indicate that the originally selected target cell is overloaded. The cause of “redirection triggered by network power saving” may indicate the redirection is due to power saving purpose.

The load information of the target cell and/or the new target cell comprises at least one of:
a PRB usage in the target cell and/or the new target cell;
a PRB usage per beam in the target cell and/or the new target cell;
a CCE usage in the target cell and/or the new target cell;
a CCE usage per beam in the target cell and/or the new target cell;
a number of active UEs in the target cell and/or the new target cell; or
a number of active UEs per beam in the target cell and/or the new target cell.

### Embodiment 4

In this embodiment, one base station initiates a handover request, to request handover a UE to a target cell in second base station. The second base station, based on its policy, and with reference to load information, may not accept the handover request, but is able to identify a new target cell in a third base station, which may be suitable for the handover. Details are described below with reference to FIG. 9.

### Step 1

Base station 1 initiates a handover request message to base station 2. This step is the same as step 1 in embodiment 3, and is not described in details herein.

### Step 2

Base station 2 may decide not to grant access to the UE in the target cell as specified in the handover request. However, there is a new target cell in base station 3 which may provide same coverage as the target cell, or the new target cell may satisfy the Quality of Service (QOS) requirement of the UE. In this case, the base station 2 may send a handover preparation failure message to base station 1. The handover preparation failure message may include information to facilitate re-directing the UE to the new target cell in base station 3. The information may include at least one of:
a cause;
a load information of the target cell (target cell may be identified by its cell identifier, such as CGI); or
a redirection information associated with the new target cell (e.g., cell identifier of the new target cell).

The cause may include at least one of: load balance, overload, network power saving, or cell to be shutdown.

The load information of the target cell comprises at least one of:
a PRB usage in the target cell;
a PRB usage per beam in the target cell;
a CCE usage in the target cell;
a CCE usage per beam in the target cell;
a number of active UEs in the target cell; or
a number of active UEs per beam in the target cell.

### Step 3

After receiving the handover preparation failure message from base station 2, the base station 1 may send a new handover request message to base station 3, which may include an identifier of the new target cell in base station 3, to request handover the UE to the new target cell in base station 3.

### Embodiment 5

In this embodiment, one base station initiates a handover request, to request handover a UE to a target cell in second base station. The second base station, based on its policy, and with reference to load information, may not accept the handover request, and may not be able to decide the new target cell for handover, but is able to identify a target carrier for the handover. Details are described below with reference to FIG. 10.

### Step 1

Base station 1 initiates a handover request message to base station 2. This step is the same as step 1 in embodiment 3, and is not described in details herein.

### Step 2

Base station 2 may decide not to grant access to the UE in the target cell as specified in the handover request. However, base station 2 is able to identify a carrier (or a list of carriers) for handover. In this case, the base station 2 may send a handover preparation failure message to base station 1. The handover preparation failure message may include information to facilitate the UE to perform measurement on the identified carrier for handover. The information may include at least one of:
a cause;
a load information of the target cell, or cells managed by base station 2; or
a redirection information associated with the target carrier;

The cause may include at least one of: redirection triggered by load balance, redirection triggered by overload, redirection triggered by network power saving, or redirection triggered by cell to be shutdown.

The load information of the target carrier may include at least one of:
a PRB usage in the target cell, or cells managed by base station 2;
a PRB usage per beam in the target cell, or cells managed by base station 2;
a CCE usage in the target cell, or cells managed by base station 2;
a CCE usage per beam in the target cell, or cells managed by base station 2;
a number of active UEs in the target cell, or cells managed by base station 2; or
a number of active UEs per beam in the target cell, or cells managed by base station 2.

The load information may also include load information for cells of base station 2.

### Step 3

After receiving the handover preparation failure message from base station 2, the base station 1 may send an RRC reconfiguration message to the UE, to trigger the UE to perform direct measurement. The RRC reconfiguration request may include a measurement configuration (measConfig) carrying target carrier information. The target carrier information may include measurement object information. The UE may then perform direct measurement based on measurement configuration.

In Embodiments 3-5, the handover procedure, base station 1 and base station 2 use Xn Application Protocol (XnAP) to exchange handover related message over the Xn interface. The same underline principle may be used for NG Application Protocol (NGAP) based handover over the NGAP interface.

For example, the HANDOVER REQUEST message in FIGS. 8-10 may be applied to HANDOVER REQUIRED and HANDOVER REQUEST message over the NGAP interface. In particular, as described in embodiment 3, both the HANDOVER REQUIRED and HANDOVER REQUEST message over the NGAP interface may include similar information comprised in the handover request in FIG. 8. The information may include at least one of: the identifier of the target cell identified by the source base station, a handover cause, a load information of the source cell or cells managed by source base station, or a power saving mode associated with source base station.

For another example, the HANDOVER REQUEST ACKNOWLEDGE message (as shown in FIG. 8) may be applied to HANDOVER REQUEST ACKNOWLEDGE and HANDOVER COMMAND message over the NGAP interface. In particular, the HANDOVER REQUEST ACKNOWLEDGE and HANDOVER COMMAND message over the NGAP interface may include similar information comprised in the Handover request acknowledge message as shown in FIG. 8. The information may include at least one of:
a cause;
a load information of the target cell and/or the new target cell (target cell and new target cell may be identified by cell identifier, such as CGI);
a redirection information associated with the new target cell; or
an RRC reconfiguration information associated with the new target cell.

For another example, the HANDOVER PREPARATION FAILURE message in FIGS. 9-10 may be applied to HANDOVER FAILURE and HANDOVER PREPARATION FAILURE message over the NGAP interface. In particular, both the HANDOVER FAILURE and HANDOVER PREPARATION FAILURE message over the NGAP interface may include the same content as in the handover preparation failure message shown in FIG. 9 or FIG. 10. The message may include at least one of: redirection information with new target cell ID or new carrier, cause, or load information.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1-15. (canceled)

16. A method for wireless communication, performed by a first network element (NE) in a wireless network, the method comprising:
a first handover request message requesting to hand over a User Equipment (UE) from a source cell in the first NE to a first cell in a second NE, the first handover request message comprising at least one of:
an identifier of the first cell;
a handover cause;
a load information of the source cell or cells managed by the first NE; or
a power saving mode associated with a power saving in the first NE.

17. The method of claim 16, wherein each of the first NE and the second NE comprises at least one of: a gNB, an eNB, or an ng-eNB.

18. The method of claim 16, wherein the handover cause comprises at least one of:
a load aggregation from the first NE to the second NE;
a load balance between the first NE and the second NE;
an overload condition in the first NE;
network power saving in the first NE; or
cell shutdown in the first NE.

19. The method of claim 16, wherein the load information of the source cell or the cells managed by the first NE comprises at least one of:
a Physical Resource Block (PRB) usage of the source cell or the cells managed by the first NE;
a Control Channel Element (CCE) usage of the source cell or the cells managed by the first NE; or
a number of active UEs in the source cell or the cells managed by the first NE.

20. The method of claim 16, wherein the power saving mode comprises at least one of:
a cell shutdown mode in which at least one cell is shutdown;
a carrier shutdown mode in which at least one carrier is shutdown;
a beam shutdown mode in which at least one beam is shutdown;
a slot shutdown mode in which at least one slot is shutdown;
a symbol shutdown mode in which at least one symbol is shutdown;
a deep sleep mode;
a light sleep mode; or
a normal mode.

21. The method of claim 16, further comprising:
receiving an acknowledge to the first handover request message, the acknowledge comprising redirection information indicating that the UE is to be redirected to a second cell in the second NE, and the acknowledge further comprising at least one of:
a cause;
a load information of the first cell;
a load information of the second cell; or
an RRC reconfiguration information associated with the second cell.

22. The method of claim 21, wherein the cause comprises at least one of:
load balance between cells or between carriers;
overload;
network power saving; or
cell shutdown.

23. The method of claim 21, wherein the load information of the second cell comprises at least one of:
a PRB usage in the second cell;
a PRB usage per beam in the second cell;
a CCE usage in the second cell;
a CCE usage per beam in the second cell;
a number of active UEs in the second cell; or
a number of active UEs per beam in the second cell.

24. The method of claim 16, further comprising:
receiving a response to the first handover request message, the response comprising redirection information indicating that the UE is to be redirected to a third cell in a third NE, and the response further comprising at least one of:
a cause;
a load information of the second cell; or
an identifier of the third cell.

25. The method of claim 24, wherein the third NE comprises at least one of: a gNodeB (gNB), an eNodeB (eNB), or an ng-eNB.

26. The method of claim 24, wherein the cause comprises at least one of:
load balance between cells or between carriers;
overload;
network power saving; or
cell shutdown.

27. The method of claim 24, wherein the load information of the second cell comprises at least one of:
a PRB usage in the second cell;
a PRB usage per beam in the second cell;
a CCE usage in the second cell;
a CCE usage per beam in the second cell;
a number of active UEs in the second cell; or
a number of active UEs per beam in the second cell.

28. The method of claim 24, further comprising:
transmitting, to the third NE, a second handover request message requesting to hand over the UE to the third cell in the third NE.

29. The method of claim 16, further comprising:
receiving a response to the first handover request message, the response indicating a failure to handover the UE to the first cell and a redirection to a target carrier, and the response further comprising:
a target carrier information of the target carrier selected for the UE for performing a hand over;
a cause;
a load information of the second cell; or
a load information of cells managed by the second NE.

30. The method of claim 29, wherein the cause comprises at least one of:
redirection;
load balance;
overload;
network power saving; or
cell shutdown.

31. The method of claim 29, wherein the load information of the second cell comprises at least one of:
a PRB usage in the second cell;
a PRB usage in the second cell;
a PRB usage per beam in the second cell;
a CCE usage in the second cell;
a CCE usage per beam in the second cell;
a number of active UEs in the second cell; or
a number of active UEs per beam in the second cell.

32. The method of claim 29, further comprising:
transmitting, to the UE, an RRC reconfiguration request comprising measurement configuration information associated with the target carrier, RRC reconfiguration request triggering the UE to perform a measurement based on the measurement configuration information.

33. A device for wireless communication comprising a memory for storing computer instructions and a processor in communication with the memory, wherein, when the processor executes the computer instructions, the processor is configured to implement:
transmitting a first handover request message requesting to hand over a User Equipment (UE) from a source cell in the first NE to a first cell in a second NE, the first handover request message comprising at least one of:
an identifier of the first cell;
a handover cause;
a load information of the source cell or cells managed by the first NE; or
a power saving mode associated with a power saving in the first NE.

34. A non-transitory computer-readable program medium with computer code stored thereupon, the computer code, when executed by one or more processors, causing the one or more processors to implement:
transmitting a first handover request message requesting to hand over a User Equipment (UE) from a source cell in the first NE to a first cell in a second NE, the first handover request message comprising at least one of:
an identifier of the first cell;
a handover cause;
a load information of the source cell or cells managed by the first NE; or
a power saving mode associated with a power saving in the first NE.
